(19) United States
(12) Patent Application Publication
(10) Pub. No.: US 2018/0273739 A1
(43) Pub. Date: Sep. 27, 2018

(54) RESIN COMPOSITION, RESIN MOLDED ARTICLE, AND METHOD FOR PRODUCING RESIN COMPOSITION

(71) Applicant: FUJI XEROX CO., LTD., Tokyo (JP)

(72) Inventors: Hiroyuki MORIYA, Kanagawa (JP); Masayuki OKOSHI, Kanagawa (JP); Tsuyoshi MIYAMOTO, Kanagawa (JP)

(73) Assignee: FUJI XEROX CO., LTD., Tokyo (JP)

(21) Appl. No.: 15/671,666

(22) Filed: Aug. 8, 2017

(30) Foreign Application Priority Data
Mar. 24, 2017 (JP) 2017-058889

(51) Int. Cl. C08L 23/12; C08L 23/06; C08L 77/02

(52) U.S. Cl. CPC C08L 23/12; C08L 23/06; C08L 2205/035; C08L 2205/025; C08L 2310/00; C08L 77/02

(57) ABSTRACT

A resin composition contains a polyolefin; 0.1 parts by mass or more and 200 parts by mass or less of carbon fibers, over 20 parts by mass and 100 parts by mass or less of polyamide, and 1 part by mass or more and 50 parts by mass or less of a compatibilizer relative to 100 parts by mass of the polyolefin; and 2 parts by mass or more and 20 parts by mass or less of a coloring agent having a polar group relative to 100 parts by mass of the carbon fibers.

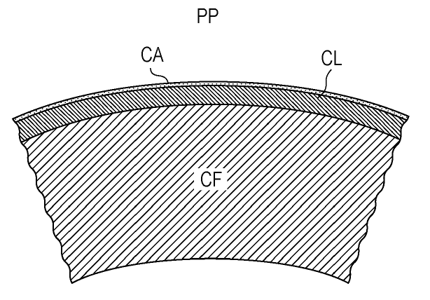

### CROSS-REFERENCE TO RELATED APPLICATIONS

This application is based on and claims priority under 35 USC 119 from Japanese Patent Application No. 2017-058889 filed Mar. 24, 2017.

### BACKGROUND

### (i) Technical Field

The present invention relates to a resin composition, a resin molded article, and a method for producing a resin composition.

### (ii) Related Art

Various resin compositions have been provided and used for various applications

In particular, resin compositions containing polyolefin as a thermoplastic resin are used for components, housings, etc. of home appliances and automobiles, and components such as housings and the like of office equipment, and electronic/electric equipment.

### SUMMARY

According to an aspect of the invention, there is provided a resin composition including a polyolefin; 0.1 parts by mass or more and 200 parts by mass or less of carbon fibers, over 20 parts by mass and 100 parts by mass or less of polyamide, and 1 part by mass or more and 50 parts by mass or less of a compatibilizer relative to 100 parts by mass of the polyolefin; and 2 parts by mass or more and 20 parts by mass or less of a coloring agent having a polar group relative to 100 parts by mass of the carbon fibers.

### BRIEF DESCRIPTION OF THE DRAWINGS

Exemplary embodiments of the present invention will be described in detail based on the following figure, wherein:

FIGURE is a schematic drawing for explaining an example of a principal portion of a resin molded article according to an exemplary embodiment of the present invention.

### DETAILED DESCRIPTION

An example of each of a resin composition and a resin molded article according to an exemplary embodiment of the present invention is described below.

### [Resin Composition]

A resin composition according to the exemplary embodiment contains a polyolefin, carbon fibers, a polyamide, a resin containing a coloring agent having a polar group (also referred to as a “polar group-containing coloring agent” hereinafter), and a compatibilizer.

The content of the carbon fibers is 0.1 parts by mass or more and 200 parts by mass or less, the content of the polyamide is over 20 parts by mass and 100 parts by mass or less, the content of the compatibilizer is 1 part by mass or more and 50 parts by mass or less, and the content of the polar group-containing coloring agent is 2 parts by mass or more and 20 parts by mass or less.

The content of each of the carbon fibers, the polyamide, and the compatibilizer is the content relative to 100 parts by mass of the polyolefin. On the other hand, the content of the polar group-containing coloring agent is the content relative to 100 parts by mass of the carbon fibers.

A resin composition containing a polyolefin serving as a matrix and carbon fibers has recently been used for obtaining a resin molded article having excellent mechanical strength.

On the other hand, a coloring agent is mixed with the resin composition in order to produce a resin molded article colored in a color other than black.

However, the present situation is that even when a coloring agent is mixed with a resin composition, the coloring agent is dispersed only in the polyolefin serving as the matrix and does not cover the carbon fibers. Therefore, the color black of the carbon fibers is prominent in the resultant resin molded article, thereby causing low color forming properties.

Therefore, the resin composition according to the exemplary embodiment contains the five components including the polyolefin, the carbon fibers, the polyamide, the compatibilizer, and the polar group-containing coloring agent. In addition, the content of each of the components falls in the range described above.

The configuration can produce a resin molded article having excellent color forming properties. The estimated reason for this is as follows.

In producing a resin molded article from the resin composition according to the exemplary embodiment, when the resin composition is heat-melted and mixed, the polyolefin serving as the matrix and the compatibilizer are molten, and both a portion in the molecule of the compatibilizer and the polyamide are compatibilized through amide bonds contained in the molecule of the polyamide to disperse the polyamide in the resin composition.

In this state, when the polyamide comes in contact with the carbon fibers, many amide bonds contained along the molecular chain of the polyamide are physically bonded to a few polar groups present on the surfaces of the carbon fibers due to affinity (attractive force and hydrogen bond) at plural positions. Also, the polyolefin and the polyamide generally have low compatibility therebetween, and thus the frequency of contact between the polyamide and the carbon fibers is increased due to repulsive force between the polyolefin and the polyamide, resulting in increases in the amount and area of bonding of the polyamide to the carbon fibers. Therefore, a polyamide coating layer is formed on the periphery of each of the carbon fibers.

In addition, the polyamide which forms the coating layer is compatibilized by chemical reaction with a reactive group in the molecule of the compatibilizer and by electrostatic interaction between the polar groups, and thus the compatibilizer is compatibilized with the polyolefin, thereby forming an equilibrium state between the attractive force and the repulsive force. Therefore, the coating layer formed of the polyamide is thinly and nearly uniformly formed. In particular, because of high affinity between the carboxyl groups present on the surfaces of the carbon fibers and the amide bonds contained in the molecule of the polyamide, the coating layer formed of the polyamide is considered to be easily formed on the periphery of each of the carbon fibers and become thin and excellent in uniformity.

In particular, when the content of the polyamide is as high as within a range of over 20 parts by mass and 100 parts by mass or less relative to 100 parts by mass of the polyolefin, the amount of the compatibilizer relative to the amount of the polyamide is decreased, and the polyamide is hardly spread in the polyolefin, thereby increasing the tendency to localization on the periphery of each of the carbon fibers. This is considered to allow the coating layer formed of the polyamide to be somewhat thickly and nearly uniformly formed over the entire periphery of each of the carbon fibers.

The coating layer is formed to cover the entire periphery of each of the carbon fibers, but the carbon fibers may be partially uncoated.

While, when the coloring agent having a polar group is mixed together with the polyamide having the function described above, attractive force acts between the both due to the affinity between the amide bonds contained in the molecule of the polyamide and the polar group of the coloring agent, and thus the coloring agent is easily mixed with the polyamide. In addition, the coloring agent having a polar group has low affinity for polypropylene, and repulsive force acts from polypropylene. The repulsive force further promotes the attractive function and makes the coloring agent easy to mix with the polyamide.

Therefore, the coating layer of the colored polyamide colored with the coloring agent is easily formed on the periphery of each of the carbon fibers to cover the carbon fibers. Thus, the color of the coloring agent becomes dominant in the resultant resin molded article.

Further, excessive polyamide containing the coloring agent which does not coat the surfaces of the carbon fibers is considered to be dispersed in the form of microcells by the compatibilizer, forming a bright color.

In view of the above, it is considered that the resin composition according to the exemplary embodiment produces the resin molded article having excellent coloring forming properties.

Also, in the resin composition according to the exemplary embodiment, adhesion between the carbon fibers and the polyolefin as the matrix is enhanced by the coating layer formed of the polyamide, and the coloring agent is hardly dispersed in the polyolefin as the matrix, but localized in the coating layer formed of the polyamide. Thus, the resin molded article having excellent impact resistance can be easily produced.

The resin composition (and the resin molded article thereof) according to the exemplary embodiment has a structure in which the coating layer formed of the polyamide is formed on the periphery of each of the carbon fibers by heat melt-kneading and injection molding in producing the resin composition (for example, pellets), and the thickness of the collating layer is 50 nm or more and 700 nm or less.

In the resin composition according to the exemplary embodiment, the thickness of the coating layer formed of the polyamide is 50 nm or less and 700 nm or more, and is preferably 50 nm or more and 650 nm or less in view of further improvement in the color forming properties and impact resistance. The coating layer having a thickness of 50 nm or more improves the color forming properties and impact resistance, while the coating layer having a thickness of 700 nm or less suppresses weakening of the interface between the carbon fibers and the polyolefin through the coating layer and thus suppresses a decrease in impact resistance.

The thickness of the coating layer is a value measured by the following method. A measurement object is fractured in liquid nitrogen, and a section is observed by using an electron microscope (VE-9800 manufactured by Keyence Corporation). Then, the thickness of the coating layer on the periphery of each of the carbon fibers is measured at 100 points in the section, and an average is calculated.

The coating layer is confirmed by observing the section.

The resin composition (and the resin molded article thereof) according to the exemplary embodiment has, for example, a configuration in which the compatibilizer partially compatibilizes the coating layer and the polyolefin.

Specifically, for example, a layer of the compatibilizer is interposed between the polyamide coating layer and the polyolefin serving as the matrix (refer to FIGURE). That is, a layer of the compatibilizer is formed on the surface of the coating layer, and the coating layer and the polyolefin are adjacent to each other through the layer of the compatibilizer. Although the layer of the compatibilizer is formed to be thinner than the coating layer, the adhesion (bond) between the coating layer and the polyolefin is enhanced by the interposition of the layer of the compatibilizer, and thus the resin molded article having excellent mechanical strength, particularly impact resistance, can be easily produced. In FIGURE, PP denotes polyolefin, CF denotes a carbon fiber, CL denotes a coating layer, and CA denotes a layer of a compatibilizer.

The layer of the compatibilizer is interposed between the coating layer and the polyolefin in a state in which the layer of the compatibilizer is bonded to the coating layer (a hydrogen bond, a covalent bond due to reaction between the compatibilizer and polyamide functional groups, and the like) and is compatibilized with the polyolefin. This configuration can be easily realized by, for example, using as the compatibilizer, a compatibilizer having a structure, which is the same as or compatible with the polyolefin serving as the matrix, and containing, in a portion of its molecule, a part reactive with the functional group of the polyamide.

Specifically, for example, when the polyolefin, the polyamide, and a maleic anhydride-modified polyolefin as the compatibilizer are used, the layer of the maleic anhydride-modified polyolefin (layer of the compatibilizer) is interposed in a state in which a carboxyl group produced by ring opening of a maleic anhydride part is bonded by reaction with an amine residue of the polyamide layer (coating layer), and a polyolefin part is compatibilized with the polyolefin.

The interposition of the layer of the compatibilizer between the coating layer and the polyolefin is confirmed by the following method.

An infrared spectral analyzer (NICOLET 6700 FT-IR manufactured by Thermo Fisher Scientific Inc.) is used as an analyzer. For example, in the case of a resin composition (or a resin molded article) containing polypropylene (hereinafter PP) as the polyolefin, PA66 as the polyamide, and maleic acid-modified polypropylene (hereinafter MA-PP) as the modified polyolefin, IR spectra of a mixture thereof, a mixture of PP and PA66, a mixture of PP and MA-PP, and as references, a PP single material, a PA66 single material, a MA-PP single material are obtained by a KBr tablet method. Peak areas within a wavelength range of 1820 cm⁻¹ or more and 1750 cm⁻¹ or less (characteristic peak of MA-PP) derived from the acid anhydride in the mixtures are compared and analyzed. A decrease in area of the peak of acid anhydride is confirmed with the mixture of PP, PA66, and MA-PP, and thus reaction between MA-PP and PA66 is confirmed. Thus, it can be confirmed that the layer of the compatibilizer (bonding layer) is interposed between the coating layer and the polyolefin. In detail, reaction between MA-PP and PA66 causes ring opening of a cyclic maleic part of MA-PP and chemical bonding of an amine residue of PA66, thereby decreasing the cyclic maleic part. Thus, it can be confirmed that the layer of the compatibilizer (bonding layer) is interposed between the coating layer and the polyolefin.

The resin composition according to the exemplary embodiment is desirably non-crosslinked (that is, a non-crosslinked resin composition). Even when the resin composition according to the exemplary embodiment is non-crosslinked, the resin composition is useful because the resin molded article (non-crosslinked resin molded article) having excellent impact resistance can be easily produced.

Each of the components of the resin composition according to the exemplary embodiment is described in detail below.

-Polyolefin (A)-

The polyolefin serves as the matrix of the resin composition and is a resin component (also, referred to as a “matrix resin”) reinforced by the carbon fibers.

One type of polyolefin may be used, or two or more types may be used in combination.

The polyolefin is a resin containing a repeating unit derived from olefin and may contain a repeating unit derived from a monomer other than the olefin as long as the content is 30% by mass or less relative to the whole resin.

The polyolefin is produced by addition polymerization of olefin (and, if required, a monomer other than the olefin).

In addition, one type or two or more types of each of the olefin and a monomer other than the olefin may be used for producing the polyolefin.

The polyolefin may be either a copolymer or a homopolymer. Also, the polyolefin may be either linear or branched.

Examples of the olefin include linear or branched aliphatic olefins and alicyclic olefins.

Examples of aliphatic olefins include a-olefins such as ethylene, propylene, 1-butene, 1-hexene, 4-methyl-1-pentene, 1-octene, 1-decene, 1-hexadecene, 1-octadecene, and the like.

Examples of alicyclic olefins include cyclopentene, cycloheptene, norbornene, 5-methyl-2-norbornene, tetracyclododecene, vinylcyclohexane, and the like.

Among these, in view of cost, α-olefins are preferred, ethylene and propylene are more preferred, and propylene is particularly preferred.

A monomer other than the olefin is selected from known addition-polymerizable compounds.

Examples of the addition-polymerizable compounds include styrenes such as styrene, methylstyrene, α-methylstyrene, β-methylstyrene, tert-butylstyrene, chlorostyrene, chloromethylstyrene, methoxystyrene, styrenesulfonic acid or salts thereof; (meth)acrylic acid esters such as alkyl (meth)acrylates, benzyl (meth)acrylate, dimethylaminoethyl (meth)acrylate, and the like; halovinyls such as vinyl chloride and the like; vinyl esters such as vinyl acetate, vinyl propionate, and the like; vinyl ethers such as vinyl methyl ether and the like; vinylidene halides such as vinylidene chloride and the like; N-vinyl compounds such as N-vinylpyrrolidone and the like; and the like.

Preferred examples of the polyolefin include polypropylene (PP), polyethylene (PE), polybutene, polyisobutylene, a coumarone-indene resin, a terpene resin, an ethylene-vinyl acetate copolymer resin (EVA), and the like.

In particular, a resin containing only a repeating unit derived from olefin is preferred, and polypropylene is particularly preferred in view of cost.

The molecular weight of the polyolefin is not particularly limited and may be determined according to the type of the resin used, molding conditions, application of the resin molded article, etc. For example, the weight-average molecular weight (Mw) of the polyolefin is preferably within a range of 10,000 or more and 300,000 or less and more preferably within a range of 10,000 or more and 200,000 or less.

Similarly to the molecular weight, the glass transition temperature (Tg) or melting point (Tm) of the polyolefin is not particularly limited and may be determined according to the type of the resin used, molding conditions, application of the resin molded article, etc. For example, the melting point (Tm) of the polyolefin is preferably within a range of 100° C. or more 300° C. or less and more preferably within a range of 150° C. or more and 250° C. or less.

The weight-average molecular weight (Mw) and melting temperature (Tm) of the polyolefin are represented by values measured as follows.

That is, the weight-average molecular weight (Mw) of the polyolefin is determined by gel permeation chromatography (GPC) under conditions described below. High temperature GPC system “HLC-8321GPC/HT” is used as a GPC apparatus, and o-dichlorobenzene is used as an eluent. The polyolefin is once dissolved in o-dichlorobenzene and filtered at a high temperature (temperature of 140° C. or more and 150° C. or less), and a filtrate is used as a measurement sample. Measurement is performed by using a RI detector under the conditions including a sample concentration of 0.5%, a flow rate of 0.6 ml/min, and a sample injection amount of 10 μl. A calibration curve is formed by using 10 samples of “polystyrene standard samples TSK standard” manufactured by Tosoh Corporation, such as “A-500”, “F-1”, “F-10”, “F-80”, “F-380”, “A-2500”, “F-4”, “F-40”, “F-128”, and “F-700”.

The melting temperature (Tm) of the polyolefin is determined from a DSC curve obtained by differential scanning calorimetry (DSC) according to “Melting Peak Temperature” described in “Determination of Melting Temperature” in JIS K 7121-1987 “Testing Methods for Transition Temperatures of Plastics”.

The content of the polyolefin may be determined according to application of the resin molded article or the like, but is, for example, preferably 5% by mass or more and 95% by mass or less, more preferably 10% by mass or more and 95% by mass or less, and still more preferably 20% by mass or more and 95% by mass or less relative to the total mass of the resin composition.

### -Carbon Fibers-

Known carbon fibers are used as the carbon fibers, and either PAN-based carbon fibers or pitch-based carbon fibers can be used.

The carbon fibers may be subjected to known surface treatment.

Examples of surface treatment of the carbon fibers include oxidation treatment, sizing treatment, and the like.

The form of the carbon fibers is not particularly limited and may be selected according to application of the resin molded article or the like. Examples of the form of the carbon fibers include a fiber bundle configurated by many single fibers, a collection of fiber bundles, a fabric formed by two-dimensionally or three-dimensionally weaving fibers, and the like.

The fiber diameter, fiber length, and the like of the carbon fibers are particularly not limited and may be selected according to application of the resin molded article etc.

However, the resin molded article having excellent impact resistance can be produced even by using the carbon fibers having a short length, and thus the average fiber length of the carbon fibers may be 0.1 mm or more and 2.5 mm or less (preferably 0.2 mm or more and 2.0 mm or less).

Also, the average fiber diameter of the carbon fibers may be, for example, 5.0 μm or more and 10.0 μm or less (preferably 6.0 μm or more and 8.0 μm or less).

With decreasing length of the carbon fibers, the resin-reinforcing ability of the carbon fibers tends to decrease. In particular, the recent demand for recycling promotes the reuse of the ground resin molded article reinforced by the carbon fibers, and thus the fiber length of the carbon fibers is often shortened during grinding of the resin molded article. In addition, the fiber length of the carbon fibers may be shortened by heat-melt kneading for producing the resin composition. Therefore, when the resin molded article is molded by using the resin composition containing the carbon fibers having a short fiber length, the tendency of decreasing mechanical strength, particularly impact resistance, is increased.

However, even when a recycled material containing the carbon fibers made short fibers by grinding the resin molded article containing the carbon fibers is used as a raw material or when the carbon fibers are made short fibers during heat-melt kneading, the resin composition according to the exemplary embodiment is useful because the resin molded article having excellent impact resistance can be easily produced.

A method for measuring the average fiber length of the carbon fibers is as follows. The length of a carbon fiber is measured by observing the carbon fiber with an optical microscope at a magnification of 100×. The measurement is performed for 200 carbon fibers, and an average value is regarded as the average fiber length of the carbon fibers.

On the other hand, a method for measuring the average fiber diameter of the carbon fibers is as follows. The diameter of a carbon fiber is measured by observing a section of a carbon fiber in a direction perpendicular to the length direction thereof using SEM (scanning electron microscope) at a magnification of 1000×. The measurement is performed for 100 carbon fibers, and an average value is regarded as the average diameter of the carbon fibers.

A commercial product may be used as the carbon fibers.

Examples of a commercial product of the PAN-based carbon fibers include “Torayca (registered trade name)” manufactured by Toray Industries, Inc., “Tenax” manufactured by Toho Tenax Co., Ltd., “Pyrofil (registered trade name)” manufactured by Mitsubishi Rayon Co., Ltd., and the like. Other examples of a commercial product of the PAN-based carbon fibers include commercial products manufactured by Hexcel Corporation, Cytec Industries Inc., Dow-Aksa Corporation, Formosa Plastics Corporation, and SGL Corporation.

Examples of a commercial product of the pitch-based carbon fibers include “Dialead (registered trade name)” manufactured by Mitsubishi Rayon Co., Ltd., “GRANOC” manufactured by Nippon Graphite Fiber Co., Ltd., “Kreca” manufactured by Kureha Corporation, and the like. Other examples of a commercial product of the pitch-based carbon fibers include commercial products manufactured by Osaka Gas Chemical Co., Ltd., and Cytec Industries Inc.

One type or combination of two or more types of the carbon fibers may be used.

The content of the carbon fibers is 0.1 parts by mass or more and 200 parts by mass or less, preferably 1 part by mass or more and 180 parts by mass or less, and more preferably 5 parts by mass or more and 150 parts by mass or less relative to 100 parts by mass of the polyolefin serving as the matrix.

When the content of the carbon fibers is 0.1 parts by mass or more relative to 100 parts by mass of the polyolefin, an attempt can be made to reinforce the resin composition, while when the content of the carbon fibers is 200 parts by mass or less relative to 100 parts by mass of the polyolefin, moldability in molding the resin molded article is improved.

In addition, when reinforcement fibers other than the carbon fibers are used, the content of the carbon fibers is 80% by mass or more relative to the total mass of the reinforcement fibers.

Hereinafter, the content (parts by mass) relative to 100 parts by mass of the polyolefin may be abbreviated as “phr (per hundred resin)”.

When the abbreviation is used, the content of the carbon fibers is 0.1 phr or more and 200 phr or less.

### -Polyamide-

The polyamide is a resin having an amide bond. Examples of the polyamide include a resin having an amino bond in the same main chain and a resin (polyamide-imide) having an amide bond and an imide bond in the same main chain. However, the polyamide is preferably a resin not having an imide bond from the viewpoint of improvement in impact resistance.

The polyamide contains an amide bond and thus exhibits affinity for the polar groups present on the surfaces of the carbon fibers. Also, affinity is exhibited for the polar group of the polar group-containing coloring agent.

Examples of the polyamide include a polyamide produced by co-polycondensation of a dicarboxylic acid with diamine, a polyamide produced by ring-opening polycondensation of lactam, and a polyamide produced by condensation of a dicarboxylic acid with diamine and lactam. That is, the polyamide is, for example, a polyamide having at least one of a structural unit formed by polycondensation of a dicarboxylic acid with diamine and a structural unit formed by ring-opening of lactam.

The polyamide having the structural unit formed by polycondensation of a dicarboxylic acid with diamine or the structural unit formed by ring-opening of lactam may be any one of a polyamide having a structural unit containing an aromatic ring excluding an aramid, a polyamide having a structural unit not containing an aromatic ring, and a polyamide having a structural unit containing an aromatic ring excluding an aramid structural unit and a structural unit not containing an aromatic ring. However, the polyamide having a structural unit containing an aromatic ring excluding an aramid structural unit and a structural unit not containing an aromatic ring is preferred in view of improvement in impact resistance.

In particular, when the polyamide having a structural unit containing an aromatic ring excluding an aramid structural unit and a structural unit not containing an aromatic ring is applied, affinity for both the carbon fibers and the polyolefin is improved. A polyamide having only a structural unit containing an aromatic ring tends to have high affinity for the carbon fibers and low affinity for the polyolefin as compared with a polyamide having only a structural unit not containing an aromatic ring. A polyamide having only a structural unit not containing an aromatic ring tends to have low affinity for the carbon fibers and high affinity for the polyolefin as compared with a polyamide having only a structural unit containing an aromatic ring. Therefore, by applying the polyamide having both structural units, affinity for both the carbon fibers and the polyolefin is improved, and thus interfacial adhesion between the carbon fibers and the polyolefin through the coating layer is further enhanced by the polyamide. Therefore, the resin molded article having excellent mechanical strength, particularly impact resistance, can be more easily produced.

Also, when the polyamide having a structural unit containing an aromatic ring excluding an aramid structural unit and a structural unit not containing an aromatic ring is applied, melt viscosity is decreased, and moldability (for example, injection moldability) is also improved. Therefore, the resin molded article having high appearance quality can be easily produced.

While when polyamide having only an aramid structural unit is applied as the polyamide, thermal deterioration of the polyolefin is brought about at a high temperature where the polyamide can be melted. Also, the polyamide is not sufficiently melted at a temperature which causes thermal deterioration of the polyolefin, thereby degrading moldability (for example, injection moldability) and decreasing the appearance quality and mechanical performance of the resultant resin molded article.

The term “aromatic ring” represents a 5- or more-membered monocyclic aromatic ring (cyclopentadiene or benzene) and a condensed ring (naphthalene ring) formed by condensation of plural 5- or more-membered monocyclic aromatic rings. The aromatic ring includes a heterocyclic ring (pyridine ring or the like).

The term “aramid structural unit” represents a structural unit formed by polycondensation reaction of a dicarboxylic acid containing an aromatic ring with diamine containing an aromatic ring.

The structural unit containing an aromatic ring excluding an aramid structural unit is, for example, at least one of structural unis (1) and (2) below.

Structural unit (1): —(—NH—Ar¹—NH—CO—R¹—CO—)—

(In the structural unit (1), Ar¹ represents a divalent organic group containing an aromatic ring, and R¹ represents a divalent organic group not containing an aromatic ring.)

Structural unit (2): —(—NH—R²—NH—CO—Ar²—CO—)—

(In the structural unit (2), Ar² represents a divalent organic group containing an aromatic ring, and R² represents a divalent organic group not containing an aromatic ring.)

On the other hand, the structural unit not containing an aromatic ring is, for example, at least one of structural unis (3) and (4) below.

Structural unit (3): —(—NH—R³¹—NH—CO—R³²—CO—)—

(In the structural unit (3), R³¹ represents a divalent organic group not containing an aromatic ring, and R³² represents a divalent organic group not containing an aromatic ring.)

Structural unit (4): —(—NH—R⁴—CO—)—

(In the structural unit (4), R⁴ represents a divalent organic group not containing an aromatic ring.)

In the structural units (1) to (3), a “divalent organic group” represented by each of the symbols is an organic group derived from a divalent organic group possessed by a dicarboxylic acid, diamine, or lactam. Specifically, for example, in the structural unit (1), a “divalent organic group containing an aromatic ring” represented by Ar′ represents a residue remaining after removing two amino groups from diamine, and a “divalent organic group not containing an aromatic ring” represented by R² represents a residue remaining after removing two carboxyl groups from dicarboxylic acid. In addition, for example, in the structural unit (4), a “divalent organic group not containing an aromatic ring” represented by R⁴ represents an organic group held between a “NH group” and a “CO group” produced by ring opening of lactam.

Examples of the polyamide include copolymerized polyamide and mixed polyamide. The copolymerized polyamide and the mixed polyamide may be used in combination as the polyamide. In particular, in view of further improvement in impact resistance, the mixed polyamide is preferred as the polyamide.

The copolymerized polyamide is, for example, a copolymerized polyamide produced by copolymerizing a first polyamide having a structural unit containing an aromatic ring excluding an aramid structural unit and a second polyamide having a structural unit not containing an aromatic ring.

The mixed polyamide is, for example, a mixed polyamide containing a first polyamide containing an aromatic ring and a second polyamide not containing an aromatic ring.

For the sake of convenience, the first polyamide and the second polyamide may be referred to as the “aromatic polyamide” and the “aliphatic polyamide”, respectively, hereinafter.

In the copolymerized polyamide, the ratio (aromatic polyamide/aliphatic polyamide) in terms of mass ratio of the aromatic polyamide to the aliphatic polyamide is 20/80 or more and 99/1 or less (preferably 50/50 or more and 96/4 or less) in view of further improvement in impact resistance.

In the mixed polyamide, the ratio (aromatic polyamide/aliphatic polyamide) in terms of mass ratio of the aromatic polyamide to the aliphatic polyamide is 20/80 or more and 99/1 or less (preferably 50/50 or more and 96/4 or less) in view of further improvement in impact resistance.

The ratio of the structural unit containing an aromatic ring in the aromatic polyamide is 80% by mass or more (preferably 90% by mass or more and more preferably 100% by mass) relative to the total structural unit.

The ratio of the structural unit not containing an aromatic ring in the aliphatic polyamide is 80% by mass or more (preferably 90% by mass or more and more preferably 100% by mass) relative to the total structural unit.

Examples of the aromatic polyamide include a polycondensate of a dicarboxylic acid containing an aromatic ring with a diamine not containing an aromatic ring, a polycondensate of a dicarboxylic acid not containing an aromatic ring with a diamine containing an aromatic ring, and the like.

Examples of the aliphatic polyamide include a polycondensate of a dicarboxylic acid not containing an aromatic ring with a diamine not containing an aromatic ring, a ring-opened polycondensate of lactam not containing an aromatic ring, and the like.

Examples of a dicarboxylic acid containing an aromatic ring include phthalic acid (terephthalic acid, isophthalic acid, and the like), biphenyl dicarboxylic acid, and the like.

Examples of a dicarboxylic acid not containing an aromatic ring include oxalic acid, adipic acid, suberic acid, sebacic acid, 1,4-cyclohexane dicarboxylic acid, malonic acid, succinic acid, glutaric acid, pimelic acid, azelaic acid, and the like.

Examples of a diamine containing an aromatic ring include p-phenylenediamine, m-phenylenediamine, m-xylenediamine, diaminodiphenylmethane, diaminodiphenyl ether, and the like.

Examples of a diamine not containing an aromatic ring include ethylenediamine, pentamethylenediamine, hexamethylenediamine, nonanediamine, decamethylenediamine, 1,4-cyclohexanediamine, and the like.

Examples of lactam not containing an aromatic ring include ε-caprolactam, undecanelactam, lauryllactam, and the like.

The dicarboxylic acids may be used alone or in combination of two or more. This is true for the diamines and the lactams

Examples of the aromatic polyamide include MXD6 (polycondensate of adipic acid and meta-xylenediamine), nylon 6T (polycondensate of terephthalic acid and hexamethylenediamine), nylon 6I (polycondensate of isophthalic acid and hexamethylenediamine), nylon 9T (polycondensate of terephthalic acid and nonanediamine), nylon M5T (polycondensate of terephthalic acid and methylpentadiamine), and the like.

Examples of a commercial product of the aromatic polyamide include “MXD6” manufactured by Mitsubishi Gas Chemical Co. Inc., “GENESTAR (registered trade name): PA6T” manufactured by Kuraray Co., Ltd., “GENESTAR (registered trade name): PA9T” manufactured by Kuraray Co., Ltd., “TY-502NZ: PA6T” manufactured by Toyobo Co., Ltd., and the like.

Examples of the aliphatic polyamide include nylon 6 (ring-opened polycondensate of c-caprolactam), nylon 11 (ring-opened polycondensate of undecanelactam), nylon 12 (ring-opened polycondensate of lauryllactam), nylon 66 (polycondensate of adipic acid and hexamethylenediamine), nylon 610 (polycondensate of sebacic acid and hexamethylenediamine), and the like.

Examples of a commercial product of the aliphatic polyamide include “Zytel (registered trade mane): 7331J (PA6)” manufactured by Dupont Co., Ltd., “A1030BRL (PA6)” manufactured by Unitika Ltd., “Zytel (registered trade name): 101L (PA66)” manufactured by Dupont Co., Ltd., and the like.

The physical properties of the polyamide are described.

In view of further improvement in low-temperature impact resistance, the ratio of an aromatic ring in the polyamide (copolymerized polyamide or mixed polyamide) is preferably 1% by mass or more and 55% by mass or less, more preferably 5% by mass or more and 50% by mass or less, and still more preferably 10% by mass or more and 40% by mass or less.

The ratio of an aromatic ring in the mixed polyamide is the ratio of an aromatic ring relative to the total of the aromatic polyamide and the aliphatic polyamide.

The ratio of an aromatic ring in the polyamide represents the total ratio of a monocyclic aromatic ring and a condensed ring formed by condensation of monocyclic aromatic rings contained in the polyamide. In calculating the ratio of an aromatic ring in the polyamide, substituents in the monocyclic aromatic ring and the condensed ring formed by condensation of monocyclic aromatic rings are excluded.

That is, the ratio of an aromatic ring in the polyamide is calculated from the molecular weight of the “structural unit formed by polycondensation of dicarboxylic acid with diamine” or the “structural unit formed by ring opening of lactam” in the polyamide. This calculation determines the ratio (% by mass) of the molecular weight of an aromatic ring (when a substituent is contained, an aromatic ring without the substituent) contained in the structural unit.

First, the ratio of an aromatic ring in a typical polyamide is described below. The ratios of an aromatic ring in both nylon 6 and nylon 66 not containing an aromatic ring are 0% by mass. On the other hand, MXD6 having an aromatic ring has an aromatic ring “—C₆H₄— (molecular weight: 76.10) in its structural unit, and thus the ratio of an aromatic ring is 30.9% by mass. Similarly, the ratio of an aromatic ring in nylon 9T is 26.49% by mass.

Nylon 6: structure of the structural unit: “—NH—(CH₂)₅—CO—”, molecular weight of the structural unit=113.16, ratio of an aromatic ring=0% by mass

Nylon 66: structure of the structural unit: “—NH—(CH₂)₆—NH—CO—(CH₂)₄—CO—”, molecular weight of the structural unit=226.32, ratio of an aromatic ring=0% by mass

MXD6: structure of the structural unit: “—NH—CH₂—C₆H₄—CH₂—NH—CO—(CH₂)₄—CO—”, molecular weight of the structural unit=246.34, ratio of an aromatic ring=30.9% by mass

Nylon 9T: structure of the structural unit: “—NH—(CH₂)₉—NH—CO—C₆H₄—CO—”, molecular weight of the structural unit=288.43, ratio of an aromatic ring=26.4% by mass

The ratio of an aromatic ring in each of the copolymerized polyamide and the mixed polyamide is determined as follows.

### EXAMPLE 1

### Case of Copolymerized Polyamide or Mixed Polyamide of Nylon 6 and MXD6 (Mass Ratio of Nylon 6 to MXD6=50/50)

Ratio of aromatic ring=(ratio of nylon 6×ratio of aromatic ring in nylon 6)+(ratio of MXD6×ratio of aromatic ring in MXD6)=(0.5×0)+(0.5×30.9)=15.5 (% by mass)

### EXAMPLE 2

### Case of Copolymerized Polyamide or Mixed Polyamide of Nylon 66, MXD6, and Nylon 9T (Mass Ratio Between Nylon 66, MXD6, and Nylon 9T=50/25/25)-

Ratio of aromatic ring=(ratio of nylon 66×ratio of aromatic ring in nylon 66)+(ratio of MXD6×ratio of aromatic ring in MXD6)+(ratio of nylon 9T×ratio of aromatic ring in nylon 9T) =(0.5×0)+(0.25×30.9)+(0.25×26.4)=14.3 (% by mass)

The molecular weight of the polyamide (each of the copolymerized polyamide and the mixed polyamide) is not particularly limited as long as heat melting of the polyamide is easier than the polyolefin coexisting with the polyamide in the resin composition. For example, the weight-average molecular weight of the polyamide is preferably within a range of 10,000 or more 300,000 or less and more preferably within a range of 10,000 or more and 100,000 or less.

Similarly to the molecular weight, the glass transition temperature or melting temperature (melting point) of the polyamide (each of the copolymerized polyamide and the mixed polyamide) is not particularly limited as long as heat melting of the polyamide is easier than the polyolefin coexisting with the polyamide in the resin composition. For example, the melting point (Tm) of the polyamide (each of the copolymerized polyamide and the mixed polyamide) is preferably within a range of 100° C. or more and 400° C. or less and more preferably within a range of 150° C. or more and 300° C. or less.

The polyamide (each of the copolymerized polyamide and the mixed polyamide) is preferably a resin having low compatibility with the polyolefin, and specifically a resin having a different solubility parameter (SP value) from the polyolefin.

A difference in SP value between the polyolefin and the polyamide is preferably 3 or more and more preferably 3 or more and 6 or less in view of compatibility between the both and repulsive force between the both.

The SP value is a value calculated by a Fedor method, and specifically, the solubility parameter (SP value) is calculated by, for example, a formula below according to the description in Polym. Eng. Sci., vol. 14, p. 147 (1974). Formula: SP value=√(Ev/v)=√(ΣΔei/ΣΔvi)

(In the formula, Ev: evaporation energy (cal/mol), v: molar volume (cm³/mol), Δei: evaporation energy of each atom or each atomic group), Δvi: molar volume of each atom or each atomic group.)

The unit of solubility parameter (SP value) is “(cal/cm³)^{1/2}” but is omitted according to the practice, and the SP value is expressed by a dimensionless value.

The content of the polyamide is over 20 parts by mass and 100 parts by mass or less relative to 100 parts by mass of the polyolefin. In view of improvement in color forming properties and impact resistance, the content is preferably 30 parts by mass or more and 90 parts by mass or less and still more preferably 40 parts by mass or more and 80 parts by mass or less.

In view of improvement in color forming properties and impact resistance, the content of the polyamide relative to the carbon fibers is preferably 0.1% by mass or more and 200% by mass or less, more preferably 10% by mass or more and 150 by mass or less, and still more preferably 12% by mass or more and 120% by mass or less.

When the content of the polyamide relative to the mass of the carbon fibers is 0.1% by mass or more, affinity between the carbon fibers and the polyamide is easily enhanced, while when the content is 200% by mass or less, resin flowability is improved.

### -Compatibilizer-

The compatibilizer is a resin which enhances the affinity between the polyolefin and the polyamide.

The compatibilizer may be determined according to the polyolefin.

The compatibilizer preferably has a structure which is the same as or compatible with the polyolefin and has, in a portion of the molecule, a part having affinity for the polyamide or a part reactive with a functional group of the polyamide.

Specifically, a modified polyolefin is preferably used as the compatibilizer.

When the polyolefin is polypropylene (PP), the modified polyolefin is preferably modified polypropylene (PP). Similarly, when the polyolefin is an ethylene-vinyl acetate copolymer resin (EVA), the modified polyolefin is preferably a modified ethylene-vinyl acetate copolymer resin (EVA).

The modified polyolefin is, for example, polyolefin in which a modification part containing a carboxyl group, a carboxylic anhydride residue, a carboxylic acid ester residue, an imino group, an amino group, an epoxy group, or the like is introduced.

In view of further improvement in affinity between the polyolefin and the polyamide and the upper limit temperature of molding, the modification part to be introduced into the polyolefin preferably contains a carboxylic anhydride residue and particularly preferably contains a maleic anhydride residue.

The modified polyolefin can be produced by a direct chemical bonding method of reacting a compound containing the modification part with the polyolefin, a method of forming a graft chain by using a compound containing the modification part and then bonding the graft chain to the polyolefin, or the like.

Examples of the compound containing the modification part include maleic anhydride, citric anhydride, N-phenylmaleimide, N-cyclohexylmaleimide, glycidyl (meth)acrylate, glycidylvinyl benzoate, N-[4-(2,3-epoxypropoxy)-3, 5-dimethylbenzyl] acrylamide, alkyl (meth)acrylates, and derivatives thereof.

Among the above, preferred is a modified polyolefin produced by reacting maleic anhydride as an unsaturated carboxylic acid with the polyolefin.

Examples of the modified polyolefin include acid-modified polyolefins such as maleic anhydride-modified polypropylene, maleic anhydride-modified polyethylene, a maleic anhydride-modified ethylene-vinyl acetate copolymer resin (EVA), adducts or copolymers thereof, and the like.

A commercial product may be used as the modified polyolefin.

Examples of the modified propylene include Yumex (registered trade name) series (100TS, 110TS, 1001, 1010) manufactured by Sanyo Chemical Industries, Ltd., and the like.

Examples of the modified polyethylene include Yumex (registered trade name) series (2000) manufactured by Sanyo Chemical Industries, Ltd., Modic (registered trade name) series manufactured by Mitsubishi Chemical Corporation, and the like.

Examples of the modified ethylene-vinyl acetate resin (EVA) include Modic (registered trade name) series manufactured by Mitsubishi Chemical Corporation and the like.

The molecular weight of the compatibilizer is not particularly limited but is, in view of processability, preferably within a range of 5,000 or more and 100,000 or less and more preferably within a range of 5,000 or more and 80,000 or less.

The content of the compatibilizer is 1 part by mass or more and 50 parts by mass or less, preferably 2 parts by mass or more and 40 parts by mass or less, and still more preferably 5 parts by mass or more and 30 parts by mass or less relative to 100 parts by mass of the polyolefin.

The content of the compatibilizer is 1 part by mass or more and 100 parts by mass or less, preferably 5 parts by mass or more and 70 parts by mass or less, and still more preferably 10 parts by mass or more and 50 parts by mass or less relative to 100 parts by mass of the polyamide.

When the content of the compatibilizer is within the range, an attempt can be made to enhance affinity between the polyolefin and the polyamide and improve the color forming properties and impact resistance.

The content of the compatibilizer relative to the mass of the carbon fibers is 1% by mass or more and 100% by mass or less, preferably 5% by mass or more and 70% by mass or less, and still more preferably 10% by mass or more and 50% by mass or less.

When the content of the compatibilizer relative to the mass of the carbon fibers is 1% by mass or more, affinity between the carbon fibers and the polyamide can be easily achieved. When the content of the compatibilizer relative to the mass of the carbon fibers is 100% by mass or less, remaining of an unreacted functional group which causes discoloration and deterioration can be suppressed.

### -Polar Group-Containing Coloring Agent-

The polar group-containing coloring agent has a polar group.

The polar group may be any one of an acidic polar group, a neutral polar group, and a basic polar group.

Examples of the acidic polar group include Acid groups such as a carboxyl group (C(═O)OH), a carboxylic acid salt group, a sulfo group, a sulfonic acid salt group, a phosphoric acid group, a phosphoric acid salt group, a formyl group, a phenol group (phenolic hydroxyl group), and the like.

Examples of the neutral polar group include neutral groups such as a carbonyl group (C═O), a hydroxyl group, an amide group, a cyano group, and the like.

Examples of the basic polar group include basic groups such as an amino group, an imino group, a quaternary ammonium group, and the like.

Examples of the polar group-containing color agent include the following coloring agents.

### -Yellow Coloring Agent-

Monoazo pigments such as C.I. Pigment Yellow 1 (Fast Yellow G or the like), C.I. Pigment Yellow 74, and the like

Disazo yellow pigments such as C.I. Pigment Yellow 12 (disazo yellow or the like), C.I. Pigment Yellow 17, C.I. Pigment Yellow 97, C.I. Pigment Yellow 3, C.I. Pigment Yellow 16, C.I. Pigment Yellow 83, C.I. Pigment Yellowl 155, C.I. Pigment Yellow 219, and the like

Azolake pigments such as C.I. Pigment Yellow 100 (tartrazine yellow lake or the like) and the like

Condensed azo pigments such as C.I. Pigment Yellow 95 (condensed azo yellow or the like), C.I. Pigment Yellow 93, C.I. Pigment Yellow 94, C.I. Pigment Yellow 128, C.I. Pigment Yellow 166, and the like

Acid dye lake pigments such as C.I. Pigment Yellow 115 (quinoline yellow lake or the like), and the like

Basic dye lake pigments such as C.I. Pigment Yellow 18 (thioflavine lake or the like) and the like

Anthraquinone-based pigments such as C.I. Pigment Yellow 24 (flavanthrone yellow) and the like

Isoindolinone pigments such as Isoindolinone Yellow 3RLT (Y-110) and the like

Quinophthalone pigments such as C.I. Pigment Yellow 138 (quinophthalone yellow) and the like

Isoindoline pigments such as C.I. Pigment Yellow 139 (isoindoline yellow) and the like

Nitroso pigments such as C.I. Pigment Yellow 153 (nickel nitroso yellow or the like) and the like

Metal complex salt azomethine pigments such as C.I. Pigment Yellowl 117 (copper azomethine yellow or the like) and the like

Acetron pigments such as C.I. Pigment Yellow 120 (benzimidazolone yellow), C.I. Pigment Yellow 151, C.I. Pigment Yellow 154, C.I. Pigment Yellow 175, C.I. Pigment Yellow 180, C.I. Pigment Yellow 181, C.I. Pigment Yellow 194, and the like

Nickel azo pigments such as C.I. Pigment Yellow 150 and the like

### -Red Pigment or Magenta Pigment-

Monoazo pigments such as C.I. Pigment Red 3 (toluidine red or the like) and the like

β-naphthol pigments such as C.I. Pigment Red 1, C.I. Pigment Red 4, C.I. Pigment Red 6, and the like

Disazo pigments such as C.I. Pigment Red 38 (pyrazolone red B or the like) and the like

Azo-lake pigments such as C.I. Pigment red 53:1 (lake red C or the like), C.I. Pigment Red 57:1 (brilliant camine 6B or the like), C.I. Pigment Red 52:1, C.I. Pigment Red 48 (β-oxynaphthoic acid lake or the like), and the like

Condensed azo pigments such as C.I. Pigment Red 144 (condensed azo red or the like), C.I. Pigment Red 166, C.I. Pigment Red 220, C.I. Pigment Red 214, C.I. Pigment Red 221, C.I. Pigment Red 242, and the like

Acid dye lake pigments such as C.I. Pigment Red 174 (phloxine B lake or the like), C.I. Pigment Red 172 (erythrosine lake or the like), and the like

Basic dye lake pigments such as C.I. Pigment Red 81 (rhodamine 6G′ lake or the like) and the like

Anthraquinone-based pigments such as C.I. Pigment Red 177 (dianthraquinonyl red or the like) and the like

Thioindigo pigments such as C.I. Pigment Red 88 (thioindigo Bordeaux or the like) and the like

Perinone pigments such as C.I. Pigment Red 194 (perinone red or the like) and the like

Perylene pigments such as C.I. Pigment Red 149 (perylene scarlet or the like), C.I. Pigment Red 179, C.I. Pigment Red 178, C.I. Pigment Red 190, C.I. Pigment Red 224, C.I. Pigment Red 123, C.I. Pigment Red 224, and the like

Quinacridone pigments such as C.I. Pigment Violet 19 (unsubstituted quinacridone), C.I. Pigment Red 122 (quinacridone magenta or the like), C.I. Pigment Red 262, C.I. Pigment Red 207, C.I. Pigment Red 209, and the like, and a quinacridone pigment which is a solid solution of plural quinacridone pigments

Isoindolinone pigments such as C.I. Pigment Red 180 (isoindolinone red 2BLT or the like) and the like

Alizarin lake pigments such as C.I. Pigment Red 83 (madder lake or the like) and the like

Naphtholone pigments such as C.I. Pigment Red 171, C.I. Pigment Red 175, C.I. Pigment Red 176, C.I. Pigment Red 185, C.I. Pigment red 208, and the like

Naphthol AS-based lake pigments such as C.I. Pigment Red 247 and the like

Naphthol AS pigments such as C.I. Pigment Red 2, C.I. Pigment Red 5, C.I. Pigment Red 21, C.I. Pigment Red 170, C.I. Pigment Red 187, C.I. Pigment Red 256, C.I. Pigment Red 268, C.I. Pigment Red 269, and the like

Diketopyrolo-pyrol pigments such as C.I. Pigment Red 254, C.I. Pigment Red 255, C.I. Pigment Red 264, C.I. Pigment Red 27, and the like

### -Blue Pigment or Cyan Pigment-

Disazo pigments such as C.I. Pigment Blue 25 (dianisidine blue or the like) and the like

Phthalocyanine pigments such as C.I. Pigment Blue 15, C.I. Pigment Blue 15:1, C.I. Pigment Blue 15:2, C.I. Pigment Blue 15:3, C.I. Pigment Blue 15:4, C.I. Pigment Blue 15:6, C.I. Pigment Blue 16 (phthalocyanine blue or the like), and the like

Acid dye lake pigments such as C.I. Pigment Blue 24 (peacock blue lake or the like) and the like

Basic dye lake pigments such as C.I. Pigment Blue 1 (victoria pure blue BO lake or the like) and the like

Anthraquinone-based pigments such as C.I. Pigment Blue 60 (indanthrone blue or the like) and the like

Alkali blue pigments such as C.I. Pigment Blue 18 (alkali blue V-5:1) and the like

Among these, preferred are copper phthalocyanine pigments such as C.I. Pigment Blue 15, C.I. Pigment Blue 15:1, C.I. Pigment Blue 15:2, C.I. Pigment Blue 15:3, C.I. Pigment Blue 15:4, C.I. Pigment Blue 15:6, and the like.

### -Green Pigment-

Phthalocyanine pigments such as C.I. Pigment Green 7 (phthalocyanine green), C.I. Pigment Green 36 (phthalocyanine green), and the like

Azo metal complex pigments such as C.I. Pigment Green 8 (nitroso green), C.I. Pigment green 10, and the like

The polar group-containing coloring agent is preferably a coloring agent other than a black coloring agent (particularly, carbon black). This is because the carbon fibers showing a black color play the role as a coloring agent. However, a black coloring agent may be mixed for the purpose of increasing blackness.

The polar group-containing coloring agent used may be a coloring agent produced by surface-treating, with a surface treatment agent having a polar group, the surface of a coloring agent without a polar group, such as zinc oxide (ZnO), zinc sulfide (ZnS), titanium oxide (TiO₂), strontium titanate (SrTiO₃), or the like.

Examples of the surface treatment agent having a polar group include a silane coupling agent, various fatty acids, and the like.

The content of the polar group-containing coloring agent relative to 100 parts by mass of the carbon fibers is 2 parts by mass or more and 20 parts by mass or less, and in view of improvements in color forming properties and impact resistance, the content is preferably 3 parts by mass or more and 15 parts by mass or less and more preferably 5 parts by mass or more and 10 parts by mass or less.

The content of the polar group-containing coloring agent relative to 100 parts by mass of the polyamide is, in view of improvements in color forming properties and impact resistance, preferably 5 parts by mass or more and 20 parts by mass or less, more preferably 5 parts by mass or more and 15 parts by mass or less, and still more preferably 7 parts by mass or more and 12 parts by mass or less.

### -Other Components-

The resin composition according to the exemplary embodiment may contain components other than the above components.

Examples of the other components include known additives such as a flame retardant, a flame retardant auxiliary, an anti-dripping agent during heating, a plasticizer, an antioxidant, a mold release agent, a light resistant agent, a weather resistant agent, a modifier, an antistatic agent, a hydrolysis inhibitor, a filler, a reinforcing agent (talc, clay, mica, glass flake, milled glass, glass beads, crystalline silica, alumina, silicon nitride, aluminum nitride, boron nitride, or the like) other than carbon fibers, etc.

The content of the other components is, for example, 0 parts by mass or more and 10 parts by mass or less and preferably 0 parts by mass or more and 5 parts by mass or less relative to the 100 parts by mass of the polyolefin. The “0 parts by mass” represents a form not containing the other components.

### (Method for Producing Resin Composition)

The resin composition according to the exemplary embodiment can be produced by melt-kneading the components descried above.

A known method is used as a melt-kneading method. Examples thereof include a biaxial extruder, a Henschel mixer, a Banbury mixer, a single-screw extruder, a multi-screw extruder, a co-kneader, and the like.

The temperature (cylinder temperature) during melt-kneading may be determined according to the melting point or the like of the resin component constituting the resin composition.

In particular, the resin composition according to the exemplary embodiment can be produced by a production method including kneading the colored polyamide, which contains the polyamide and the polar group-containing coloring agent, the polyolefin, the carbon fibers, and the compatibilizer. The colored polyamide, which contains the polyamide and the polar group-containing coloring agent, is prepared, and then the colored polyamide, the polyolefin, the carbon fibers, and the compatibilizer are melt-kneaded all together. This method can easily form a thin and nearly uniform colored polyamide coating layer containing the coloring agent on the periphery of each of the carbon fibers, thereby enhancing the color forming properties. Also, the impact resistance is enhanced.

The components mixed with the colored polyamide may contain at least one of the polyamide and the polar group-containing coloring agent.

### [Resin Molded Article]

The resin molded article according to the exemplary embodiment contains the polyolefin, the carbon fibers, the polyamide, the compatibilizer, and the polar group-containing coloring agent. The content of each of the components falls within the range described above. That is, the resin molded article according to the exemplary embodiment is configured by the same composition as the resin composition according to the exemplary embodiment.

The resin molded article according to the exemplary embodiment may be produced by preparing the resin composition according to the exemplary embodiment and then molding the resin composition, or by preparing a composition containing the components other than the carbon fibers and then mixing the carbon fibers with the composition during molding. However, in preparing the composition containing the components other than the carbon fibers, the “colored polyamide containing the polyamide and the polar group-containing coloring agent” which is prepared in advance is used.

Examples of a molding method which may be used include injection molding, extrusion molding, blow molding, heat-press molding, calender molding, coating molding, cast molding, dipping molding, vacuum molding, transfer molding, and the like.

The method for molding the resin molded article according to the exemplary embodiment is preferably injection molding in view of a high degree of shape freedom.

The cylinder temperature of injection molding is, for example, 180° C. or more and 300° C. or less and preferably 200° C. or more and 280° C. or less. The mold temperature of injection molding is, for example, 30° C. or more and 100° C. or less and preferably 30° C. or more and 60° C. or less.

Injection molding may be performed by using a commercial apparatus, for example, NEX150 manufactured by Nissei Plastic Industrial Co., Ltd., NEX300 manufactured by Nissei Plastic Industrial Co., Ltd., SE5OD manufactured by Sumitomo Heavy Industries, Ltd., or the like.

The resin molded article according to the exemplary embodiment is preferably used for applications such as electronic/electric equipment, office equipment, home electric appliances, automobile interior materials, container, etc. More specific examples thereof include housings of electronic/electric equipment and home electric appliances; various components of electronic/electric equipment and home electric appliances; automobile interior components; housing cases of CD-ROM, DVD, and the like; dishes; drink bottles; food trays; wrapping materials; films; sheets; and the like.

In particular, the resin molded article according to the exemplary embodiment uses the carbon fibers as reinforcing fibers and is thus used as alternative application to metal parts because the resin molded article having excellent mechanical properties can be produced.

### EXAMPLES

The present invention is specifically described below by giving examples, but the present invention is not limited to these examples.

### Examples 1 to 14 and Comparative Examples 1 to 7

An ISO multi-purpose dumbbell test specimen (corresponding to ISO 527 tensile test and ISO 178 bending test) (test part thickness: 4 mm, width: 10 mm) and a D2 test specimen (length: 60 mm, width: 60 mm, thickness: 2 mm) are molded by using components according to Table 1 and Table 2 (in the tables, values are expressed by “parts”) and an injection molding machine (NEX150 manufactured by Nissei Plastic Industrial Co., Ltd.) at an injection molding temperature (cylinder temperature) shown in Tables 1 and 2 and a mold temperature of 50° C. Each of the test specimens is fired at 600° C. for 2 hours, and the average fiber length of residual carbon fibers is measured by the method described above. The results of measurement are shown in Tables 1 and 2.

### Evaluation

The resultant two test specimens are used for the following evaluation. The results of evaluation are shown in Table 1 and Table 2.

### -Color Forming Properties-

The resultant D2 test specimen is visually observed by comparison with the black color as a reference formed without the coloring agent. The color forming properties are evaluated according to the following criteria.

A: Color close to the resin and the coloring agent

B: Slightly dark color

C: Dark color (dark but not bright color)

D: Mostly black with a color portion

E: Black color (color without the coloring agent)

### -Flexural Modulus-

A flexural modulus is measured for the resultant ISO multi-purpose dumbbell test specimen by a method according to ISO 178 using a universal testing device (Autograph AG-Xplus manufactured by Shimadzu Corporation).

### -Impact Strength (Impact Resistance)-

The resultant ISO multi-purpose dumbbell test specimen is notched (thickness 4 mm) and used for measuring Charpy impact strength (kJ/m²) by using an impact testing device (DG-5 manufactured by Toyoseiki Seisaku-sho Co., Ltd.) according to the method defined in ISO 179. The larger the measured value, the higher the impact strength and the more excellent the impact resistance.

### -Presence of Coating Layer-

The resultant D2 test specimen is used for confirming the presence of the coating layer made of the polyamide according to the method described above.

TABLE 1

| | | | | Example | | | | | | | |
|---|---|---|---|---|---|---|---|---|---|---|---|
| | | | | Example | Example | Example | Example | Example | Example | Example | Example |
| | | | | 1 | 2 | 3 | 4 | 5 | 6 | 7 | 8 |
| Composition | Polyolefin | | Carbon fiber-containing polypropylene | 50 | 70 | 70 | 75 | 70 | 70 | | 40 |
| | | | Polypropylene | 20 | | | 10 | | 10 | | |
| | | | Polyethylene | | | | | | | 40 | |
| | | | EVA | | | | | | | | 30 |
| | Carbon fiber | | Carbon fiber A | | | | | | | 30 | |
| | PA | Aliphatic | PA6 | 20 | 30 | | 15 | 20 | | | |
| | | PA | PA66 | | | 30 | | | 20 | 30 | |
| | | | PA1010 | | | | | | | | |
| | | Aromatic | MXD6 | | | | | | | | 30 |
| | | PA | PA9T | | | | | | | | |

| Compatibilizer | Maleic anhydride-modified polypropylene | 1 | 3 | 3 | 2 | 2 | 2 | | |
|---|---|---|---|---|---|---|---|---|---|
| | Maleic anhydride-modified polyethylene | | | | | | | 3 | |
| | Maleic anhydride-modified EVA | | | | | | | | 3 |
| Coloring agent | Red coloring agent (R122) | 1.5 | 5 | | 0.8 | | | | |

| | | | | | |
|---|---|---|---|---|---|
| White coloring agent (TiO₂) | | | | | |
| White coloring agent (surface-treated TiO₂) | | | 2 | | |
| Blue coloring agent (PB15:3) | 3 | | | | 3 |
| Yellow coloring agent (Y-74) | | 1.8 | | 5 | |
| Red PA master batch (red 01) | | | | | |
| Red PA master batch (red 02) | | | | | |
| Red PA master batch (red 03) | | | | | |
| White PA master batch (white 01) | | | | | |
| Blue PA master batch (blue 01) | | | | | |
| Yellow PA master batch (yellow 01) | | | | | |

| | | | | | | | | | |
|---|---|---|---|---|---|---|---|---|---|
| | Total | 92.5 | 108 | 106 | 102.8 | 93.8 | 104 | 108 | 106 |
| Condition | Melt-kneading temperature of colored PA master batch (° C.) | — | — | — | — | — | — | — | — |
| | Injection molding temperature (° C.) | 240 | 240 | 280 | 240 | 240 | 280 | 280 | 240 |
| Characteristics | Color forming properties | A | A | A | B | B | A | A | A |
| | Flexural modulus (Gpa) | 11.0 | 15.0 | 17.0 | 14.5 | 14.0 | 15.5 | 12 | 8 |
| | Charpy impact strength (kJ/m²) | 14.0 | 12.0 | 9.5 | 12.0 | 11.0 | 10.0 | 11 | 11 |
| | Presence of coating layer | Yes | Yes | Yes | Yes | Yes | Yes | Yes | Yes |
| | Average fiber length of carbon fibers (mm) | 0.4 | 0.3 | 0.3 | 0.35 | 0.3 | 0.3 | 0.7 | 0.35 |
| | Number of parts of carbon fibers (relative to 100 parts of polyolefin) | 40.0 | 66.7 | 66.7 | 54.5 | 66.7 | 53.8 | 75.0 | 29.6 |
| | Number of parts of PA (relative to 100 parts of polyolefin) | 40.0 | 71.4 | 71.4 | 27.3 | 47.6 | 38.5 | 75.0 | 55.6 |
| | Number of parts of compatibilizer (relative to 100 parts of polyolefin) | 2.0 | 7.1 | 7.1 | 3.6 | 4.8 | 3.8 | 7.5 | 5.6 |
| | Number of parts of coloring agent (relative to 100 parts of carbon fibers) | 7.5 | 17.9 | 10.7 | 2.7 | 6.4 | 7.1 | 16.7 | 18.8 |
| | Number of parts of coloring agent (relative to 100 parts of PA) | 7.5 | 16.7 | 10.0 | 5.3 | 9.0 | 10.0 | 16.7 | 10.0 |

| | | | Example | | | | | |
|---|---|---|---|---|---|---|---|---|
| | | | Example | Example | Example | Example | Example | Example |
| | | | 9 | 10 | 11 | 12 | 13 | 14 |
| Composition | Polyolefin | Carbon fiber-containing polypropylene | 40 | 40 | 40 | 40 | 70 | 40 |

| | | Polypropylene | 30 | 30 | 30 | 30 | 5 | 30 |
|---|---|---|---|---|---|---|---|---|
| | | Polyethylene | | | | | | |
| | | EVA | | | | | | |
| Carbon fiber | | Carbon fiber A | | | | | | |
| PA | Aliphatic | PA6 | | | | | 20 | |
| | PA | PA66 | | | | | | |
| | | PA1010 | | | | | | |
| | Aromatic | MXD6 | | | | | | |
| | PA | PA9T | | | | | | |

| Compatibilizer | Maleic anhydride-modified polypropylene | 1.5 | 2 | 1.5 | 1 | 2 | 2 |
|---|---|---|---|---|---|---|---|
| | Maleic anhydride-modified polyethylene | | | | | | |
| | Maleic anhydride-modified EVA | | | | | | |
| Coloring agent | Red coloring agent (R122) | | | | | | |

| | | | | | | |
|---|---|---|---|---|---|---|
| White coloring agent (TiO₂) | | | | | | |
| White coloring agent (surface-treated TiO₂) | | | | | | |
| Blue coloring agent (PB15:3) | | | | | 4.5 | |
| Yellow coloring agent (Y-74) | | | | | | |
| Red PA master batch (red 01) | 20 | | | | | |
| Red PA master batch (red 02) | | | | | | |
| Red PA master batch (red 03) | | | | | | 20 |
| White PA master batch (white 01) | | 20 | | | | |
| Blue PA master batch (blue 01) | | | 20 | | | |
| Yellow PA master batch (yellow 01) | | | | 20 | | |

| | | | | | | | |
|---|---|---|---|---|---|---|---|
| | Total | 91.5 | 92 | 91.5 | 91 | 101.5 | 92 |
| Condition | Melt-kneading temperature of colored PA master batch (° C.) | 240 | 240 | 280 | 240 | — | 240 |
| | Injection molding temperature (° C.) | 240 | 240 | 280 | 240 | 240 | 240 |
| Characteristics | Color forming properties | A | A | A | A | B | B |
| | Flexural modulus (Gpa) | 8 | 7.5 | 8.2 | 8.5 | 8.8 | 8 |
| | Charpy impact strength (kJ/m²) | 11.5 | 11 | 10.8 | 10.5 | 7.2 | 10 |
| | Presence of coating layer | Yes | Yes | Yes | Yes | Yes | Yes |
| | Average fiber length of carbon fibers (mm) | 0.2 | 0.2 | 0.2 | 0.2 | 0.25 | 0.2 |
| | Number of parts of carbon fibers (relative to 100 parts of polyolefin) | 29.6 | 29.6 | 29.6 | 29.6 | 59.6 | 29.6 |
| | Number of parts of PA (relative to 100 parts of polyolefin) | 32.4 | 33.7 | 32.4 | 31.6 | 42.6 | 35.5 |
| | Number of parts of compatibilizer (relative to 100 parts of polyolefin) | 2.8 | 3.7 | 2.8 | 1.9 | 4.3 | 3.7 |
| | Number of parts of coloring agent (relative to 100 parts of carbon fibers) | 15.6 | 11.4 | 15.6 | 18.3 | 16.1 | 5.1 |
| | Number of parts of coloring agent (relative to 100 parts of PA) | 14.3 | 10.0 | 14.3 | 17.1 | 22.5 | 4.3 |

TABLE 2

| | | | | Example | | | |
|---|---|---|---|---|---|---|---|
| | | | | Comparative | Comparative | Comparative | Comparative |
| | | | | Example 1 | Example 2 | Example 3 | Example 4 |
| Composition | Polyolefin | | Carbon fiber-containing polypropylene | 70 | 70 | 75 | 50 |
| | | | Polypropylene | 30 | 30 | 10 | 15 |
| | | | Polyethylene | | | | |
| | | | EVA | | | | |
| | Carbon fiber | | Carbon fiber A | | | | |
| | PA | Aliphatic | PA6 | | | 15 | 30 |
| | | PA | PA66 | | | | |
| | | | PA1010 | | | | |
| | | Aromatic | MXD6 | | | | |
| | | PA | PA9T | | | | |

| Compatibilizer | Maleic anhydride-modified polypropylene | | 1.5 | 3 |
|---|---|---|---|---|
| | Maleic anhydride-modified polyethylene | | | |
| | Maleic anhydride-modified EVA | | | |
| Coloring agent | Red coloring agent (R122) | 2.1 | 0.3 | 5 |

White coloring agent (TiO₂)
White coloring agent (ZnS)
Blue coloring agent (PB15:3)
Yellow coloring agent (Y-74)
Red PA master batch (red 01)
Red PA master batch (red 02)
Red PA master batch (red 03)
White PA master batch (white 01)
Blue PA master batch (blue 01)
Yellow PA master batch (yellow 01)

| | | | | | |
|---|---|---|---|---|---|
| | Total | 100 | 102.1 | 101.8 | 103 |
| Condition | Melt-kneading temperature of colored PA master batch (° C.) | — | — | — | — |
| | Injection molding temperature (° C.) | 240 | 240 | 240 | 240 |
| Characteristics | Color forming properties | E | D | E | C |
| | Flexural modulus (Gpa) | 6.0 | 5.0 | 14.0 | 8.7 |
| | Charpy impact strength (kJ/m²) | 5.0 | 5.0 | 11.0 | 6.0 |
| | Presence of coating layer | No | No | Yes | Yes |
| | Average fiber length of carbon fibers (mm) | 0.3 | 0.3 | 0.35 | 0.4 |
| | Number of parts of carbon fibers (relative to 100 parts of polyolefin) | 38.9 | 38.9 | 54.5 | 44.4 |
| | Number of parts of PA (relative to 100 parts of polyolefin) | 0.0 | 0.0 | 27.3 | 66.7 |
| | Number of parts of compatibilizer (relative to 100 parts of polyolefin) | 0.0 | 0.0 | 2.7 | 6.7 |
| | Number of parts of coloring agent (relative to 100 parts of carbon fibers) | 0.0 | 7.5 | 1.0 | 25.0 |
| | Number of parts of coloring agent (relative to 100 parts of PA) | (—) | (—) | 2.0 | 16.7 |

| | | | Example | | |
|---|---|---|---|---|---|
| | | | Comparative | Comparative | Comparative |
| | | | Example 5 | Example 6 | Example 7 |
| Composition | Polyolefin | Carbon fiber-containing polypropylene | 70 | 75 | 40 |

| | | Polypropylene | 10 | 10 | 30 |
|---|---|---|---|---|---|
| | | Polyethylene | | | |
| | | EVA | | | |
| Carbon fiber | | Carbon fiber A | | | |
| PA | Aliphatic | PA6 | 20 | 15 | |
| | PA | PA66 | | | |
| | | PA1010 | | | |
| | Aromatic | MXD6 | | | |
| | PA | PA9T | | | |

| Compatibilizer | Maleic anhydride-modified polypropylene | 2 | 2 | 1 |
|---|---|---|---|---|
| | Maleic anhydride-modified polyethylene | | | |
| | Maleic anhydride-modified EVA | | | |
| Coloring agent | Red coloring agent (R122) | | | |

| | | | |
|---|---|---|---|
| White coloring agent (TiO₂) | 2 | | |
| White coloring agent (ZnS) | | 3 | |
| Blue coloring agent (PB15:3) | | | |
| Yellow coloring agent (Y-74) | | | |
| Red PA master batch (red 01) | | | |
| Red PA master batch (red 02) | | | 20 |
| Red PA master batch (red 03) | | | |
| White PA master batch (white 01) | | | |
| Blue PA master batch (blue 01) | | | |
| Yellow PA master batch (yellow 01) | | | |

| | | | | |
|---|---|---|---|---|
| | Total | 104 | 105 | 91 |
| Condition | Melt-kneading temperature of colored PA master batch (° C.) | — | — | 280 |
| | Injection molding temperature (° C.) | 240 | 240 | 280 |
| Characteristics | Color forming properties | D | D | C |
| | Flexural modulus (Gpa) | 9.0 | 13 | 10 |
| | Charpy impact strength (kJ/m²) | 7.0 | 12.5 | 9 |
| | Presence of coating layer | Yes | Yes | Yes |
| | Average fiber length of carbon fibers (mm) | 0.35 | 0.35 | 0.2 |
| | Number of parts of carbon fibers (relative to 100 parts of polyolefin) | 53.8 | 54.5 | 29.6 |
| | Number of parts of PA (relative to 100 parts of polyolefin) | 38.5 | 27.3 | 28.8 |
| | Number of parts of compatibilizer (relative to 100 parts of polyolefin) | 3.8 | 3.6 | 1.9 |
| | Number of parts of coloring agent (relative to 100 parts of carbon fibers) | 7.1 | 10.0 | 27.8 |
| | Number of parts of coloring agent (relative to 100 parts of PA) | 10.0 | 20.0 | 28.5 |

TABLE 3

| Colored PA master batch | | | | Red 01 | Red 02 | Red 03 | White 01 | Blue 01 | Yellow 01 |
|---|---|---|---|---|---|---|---|---|---|
| Composition | PA | Aliphatic | PA6 | 70 | | | | | 70 |
| | | PA | PA66 | | 70 | | | 70 | |
| | | | PA1010 | | | | | | |
| | | Aromatic | MXD6 | | | 70 | 70 | | |
| | | PA | PA9T | | | | | | |

| | | | | | | | |
|---|---|---|---|---|---|---|---|
| Coloring agent | Red coloring agent (R122) | 10 | 20 | 3 | | | |
| | White coloring agent (surface-treated TiO₂) | | | | 7 | | |
| | Blue coloring agent (PB15:3) | | | | | 10 | |
| | Yellow coloring agent (Y-74) | | | | | | 12 |

The results described above indicate that in the examples, the resin molded article having the high color forming properties can be produced as compared with in the comparative examples.

It is also found that in the examples, the resin molded article having excellent impact resistance and flexural modulus can be produced.

In addition, the compact formed in each of the examples is analyzed by the method described above. As a result, it is confirmed that a layer of the compatibilizer used (for example, a layer of maleic anhydride-modified polypropylene) is interposed between the coating layer and the polyolefin (a layer of the compatibilizer is formed on the surface of the coating layer).

Details of the material types shown in Table 1 to Table 3 are as follows.

### -Polyolefin-

Carbon fiber-containing polypropylene: (Plastron PPCF 40, manufactured by Daicel Polymer Ltd., carbon fiber content=40% by mass (relative to polypropylene))

Polypropylene (Novatec (registered trade name) PP MA3, manufactured by Japan Polypropylene Corporation)

Polyethylene (Ultzex 20100J, manufactured by Prime Polymer Co., Ltd.)

EVA: ethylene-vinyl acetate copolymer resins (41× manufactured by Mitsui Dupont Co., Ltd.)

### -Carbon Fibers-

Carbon fiber A: (surface-treated, chopped carbon fiber Torayca (registered trade name), manufactured by Toray Industries, Inc., average fiber length 20 mm, average diameter 7 μm)

### -Polyamide-

PA6: (PA6, A1030BRL, manufactured by Unitika Ltd.)

PA66: (PA66, 101L, Dupont Co., Ltd.)

PA1010: (PA1010, Hiprolon 200, manufactured by Arkema Co. Ltd.)

MXD6: (MXD6, manufactured by Mitsubishi Gas Chemical Company, Inc.)

PAST: (Nylon 9T, GENESTAR PAST, manufactured by Kuraray Co., Ltd.)

### -Compatibilizer-

Maleic anhydride-modified polypropylene (Yumex (registered trade name) 110TS, manufactured by Sanyo Chemical Industries, Ltd.)

Maleic anhydride-modified polyethylene (Modic M142, manufactured by Mitsubishi Chemical Corporation)

Maleic anhydride-modified EVA: maleic anhydride-modified ethylene-vinyl acetate resin copolymer resin (Modic A543, manufactured by Mitsubishi Chemical Corporation)

### -Coloring Agent-

Red coloring agent (R122): C.I. Pigment Red 122 (quinacridone magenta) with a polar group

White coloring agent (TiO₂): titanium oxide (TiO₂) without a polar group

White coloring agent (surface-treated TiO₂): silane-treated titanium oxide, with a polar group

White coloring agent (ZnS): zinc sulfide without a polar group

Blue coloring agent (PB15:3): copper phthalocyanine β crystal, with a polar group

Yellow coloring agent (PY-74): monoazo pigment with a polar group

Various colored PA master batches (colored polyamide): colored PA master batch (colored polyamide) containing polyamide and the coloring agent and prepared as described below.

### -Preparation of Colored PA Master Batch (Colored Polyamide)

The polyamide and the coloring agent according to the type and the number of parts shown in Table 3 are kneaded by Banbury Mixer BB2M (Kobe Steel, Ltd.) at a kneading temperature shown in Table 1 and Table 2 for 5 minutes, preparing a kneaded product. The resultant kneaded product is rolled by two rolls and then ground by Fitz mill (manufactured by Hosakawa Micro Corporation) to produce pellets. The pellets are used as a colored PA master batch (colored polyamide)

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A resin composition comprising:
a polyolefin;
0.1 parts by mass or more and 200 parts by mass or less of carbon fibers, over 20 parts by mass and 100 parts by mass or less of a polyamide, and 1 part by mass or more and 50 parts by mass or less of a compatibilizer relative to 100 parts by mass of the polyolefin; and
2 parts by mass or more and 20 parts by mass or less of a coloring agent having a polar group relative to 100 parts by mass of the carbon fibers.

2. The resin composition according to claim 1, wherein the compatibilizer is a modified polyolefin in which a modification part containing a carboxylic anhydride residue is introduced.

3. The resin composition according to claim 2, wherein the modified polyolefin is a maleic anhydride-modified polyolefin.

4. The resin composition according to claim 1, wherein the polyolefin is at least one polyolefin selected from polypropylene, polyethylene, and ethylene-vinyl acetate copolymer resin; and
the compatibilizer is a modified polyolefin in which a modification part containing a carboxylic anhydride residue is introduced, and is at least one compatibilizer selected from modified polypropylene, modified polyethylene, and modified ethylene-vinyl acetate copolymer resin.

5. The resin composition according to claim 4, wherein the carboxylic anhydride residue is a maleic anhydride residue.

6. The resin composition according to claim 1, wherein a portion of the polyamide forms a coating layer on the periphery of each of the carbon fibers.

7. The resin composition according to claim 6, wherein a layer of the compatibilizer is interposed between the coating layer and the polyolefin.

8. The resin composition according to claim 1, wherein the average fiber length of the carbon fibers is 0.1 mm or more and 2.5 mm or less.

9. The resin composition according to claim 1, wherein the resin composition is non-crosslinked.

10. A resin molded article comprising:
a polyolefin;
0.1 parts by mass or more and 200 parts by mass or less of carbon fibers, over 20 parts by mass and 100 parts by mass or less of a polyamide, and 1 part by mass or more and 50 parts by mass or less of a compatibilizer relative to 100 parts by mass of the polyolefin; and
2 parts by mass or more and 20 parts by mass or less of a coloring agent having a polar group relative to 100 parts by mass of the carbon fibers.

11. The resin molded article according to claim 10, wherein the compatibilizer is a modified polyolefin in which a modification part containing a carboxylic anhydride residue is introduced.

12. The resin molded article according to claim 11, wherein the modified polyolefin is a maleic anhydride-modified polyolefin.

13. The resin molded article according to claim 10,
wherein the polyolefin is at least one polyolefin selected from polypropylene, polyethylene, and an ethylene-vinyl acetate copolymer resin; and
the compatibilizer is a modified polyolefin in which a modification part containing a carboxylic anhydride residue is introduced, and is at least one compatibilizer selected from modified polypropylene, modified polyethylene, and a modified ethylene-vinyl acetate copolymer resin.

14. The resin molded article according to claim 13, wherein the carboxylic anhydride residue is maleic anhydride residue.

15. The resin molded article according to claim 10, wherein a portion of the polyamide forms a coating layer on the periphery of each of the carbon fibers.

16. The resin molded article according to claim 15, wherein a layer of the compatibilizer is interposed between the coating layer and the polyolefin.

17. The resin molded article according to claim 10, wherein the average fiber length of the carbon fibers is 0.1 mm or more and 2.5 mm or less.

18. The resin molded article according to claim 10, wherein the resin molded article is non-crosslinked.

19. A method for producing a resin composition comprising:
kneading over 20 parts by mass and 100 parts by mass of polyamide relative to 100 parts by mass of a polyolefin, a colored polyamide containing 2 parts by mass or more and 20 parts by mass of a coloring agent having a polar group relative to 100 parts by mass of carbon fibers, the polyolefin, and 0.1 parts by mass or more and 200 parts by mass or less of the carbon fibers and 1 part by mass or more and 50 parts by mass or less of a compatibilizer relative to 100 parts by mass of the polyolefin.
